(19) United States
(12) Patent Application Publication
(10) Pub. No.: US 2009/0256795 A1
(43) Pub. Date: Oct. 15, 2009

(54) Display system with LED backlight means

(75) Inventors: Soshchin Naum, Changhua City (TW); Wei-Hung Lo, Taipei (TW); Chi-Ruei Tsai, Wunshan District (TW)

Correspondence Address: The Weintraub Group, P.L.C., 28580 Orchard Lake Road, Suite 140, Farmington Hills, MI, 48334, US

(73) Assignee: Chi-Ruei Tsai

(21) Appl. No.: 11/980,729

(22) Filed: Oct. 31, 2007

(30) Foreign Application Priority Data
Feb. 12, 2007 (TW) 096105008

(51) Int. Cl. G09G 3/36

(52) U.S. Cl. 345/102; 349/68

(57) ABSTRACT

A power-saving display system without color filter is disclosed to include a backlight panel, a LED backlight set controlled to emit a first light source, a second light source, and/or a third light source to the backlight panel, a LCD panel disposed at a top side of said backlight panel, and a video signal controller controlled to output a first monochrome video image, a second monochrome video image, and/or a third monochrome video image to the LCD panel for synthesizing into a color video image for display on the LCD panel.

### BACKGROUND OF THE INVENTION

1. Field of the Invention

The present invention relates to a display system and more particularly, to a power-saving, non-color filter type display system composed of a LED backlight set and a monochrome gray-tone LCD panel for displaying color video images.

2. Description of the Related Art

FIG. 1 illustrates the structure of a conventional color LCD panel. The color LCD panel 100 comprises an upper polarizer 110, an upper glass substrate 120, a color filter 130, a liquid crystal layer 140, a thin-film substrate 150, a lower glass substrate 160, a lower polarizer 170, a backlight panel 180, and a backlight source 190. This design uses a cold cathode fluorescent lamp (CCFL) for the backlight source 190. The backlight source 190 is disposed at one peripheral side of the backlight panel 180. During operation of the color LCD panel 100, white light from the backlight source 190 goes through the lower polarizer 170, and is then twisted 90 degrees by the thin-film substrate 150 and the liquid crystal layer 140 and then filtered through the color filter 130 for display.

Because the color LCD panel 100 does not emit light itself, the backlight source 190 provides the necessary light source to the color LCD panel 100. However, when the light of the backlight source 190 goes through the two polarizers 110 and 170, the brightness is reduced to about 38%, and then reduced to about 12.54% when passed the color filter 130, and then reduced to about 7% when passed through the pixel aperture ratio, and finally reduced to about 6% when absorbed by the liquid crystal layer 140 and the glass substrates 120 and 160. Therefore, the backlight source 190 must be a high power backlight source to provide the necessary brightness. However, a high power backlight source consumes much power supply. Further, because a high voltage is necessary to drive the cold cathode fluorescent lamp (CCFL) of the backlight source 190, the internal power source design of the display system must have a booster circuit to boost the voltage to the desired level for driving cold cathode fluorescent lamp (CCFL). The booster circuit design lowers the power utilization efficiency, and has a high voltage risk.

Therefore, it is desirable to provide a LED backlight type display system that eliminates the aforesaid drawbacks.

### SUMMARY OF THE INVENTION

The present invention has been accomplished under the circumstances in view. It is therefore the main object of the present invention to provide a display system with LED backlight means, which saves much power consumption and avoids a high voltage risk.

It is another object of the present invention to provide a display system with LED backlight means, which uses a monochrome gray-tone LCD panel for display color video images, eliminating the use of a color filter and saving much the manufacturing cost. In a 15″ color LCD panel, the color filter is about 26% of the total cost. Eliminating the use of a color filter in a display system greatly reduces the cost.

To achieve these and other objects of the present invention, the display system with LED backlight means comprises a backlight panel; a LED backlight set adapted to emit a first light source, a second light source, and/or a third light source to the backlight panel; a LCD panel disposed at a top side of the backlight panel; and a video signal controller adapted to. output a first monochrome video image, a second monochrome video image, and/or a third monochrome video image to the LCD panel for synthesizing into a color video image for display on the LCD panel.

### BRIEF DESCRIPTION OF THE DRAWINGS

FIG. 1 is a cutaway of a color LCD panel according to the prior art.

FIG. 2 is a cutaway, showing the structure of a display system according to the present invention.

FIG. 3 is a circuit block diagram showing the display system coupled to a computer according to the present invention.

FIG. 4 is a time sequence chart of the three single-color images outputted from the computer shown in FIG. 3.

FIG. 5 is a cutaway of an alternate form of the LED backlight set for the display system according to the present invention.

### DETAILED DESCRIPTION OF THE PREFERRED EMBODIMENT

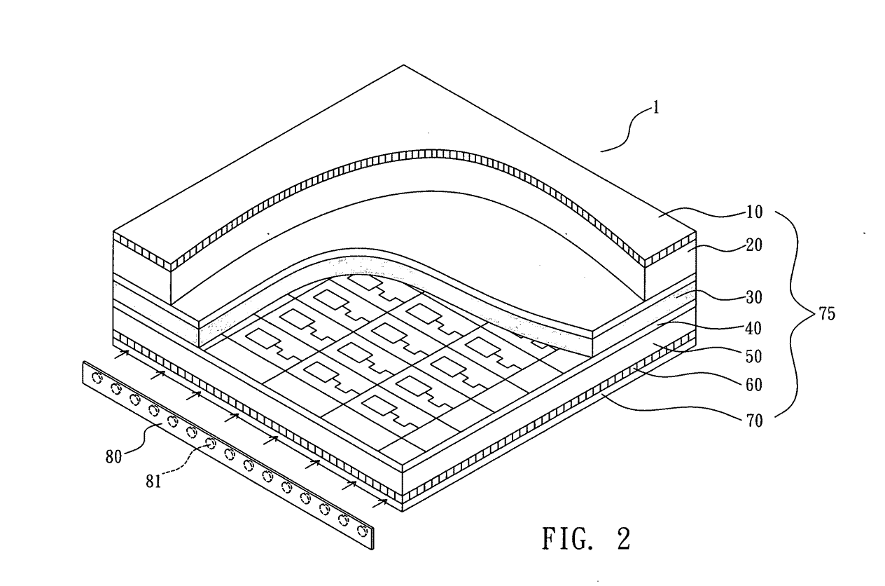

Referring to FIG. 2, a display system 1 in accordance with the present invention is shown comprised of an upper polarizer 10, an upper glass substrate 20, a liquid crystal layer 30, a thin-film substrate 40, a lower glass substrate 50, a lower polarizer 60, a backlight panel 70, and a LED backlight unit 80.

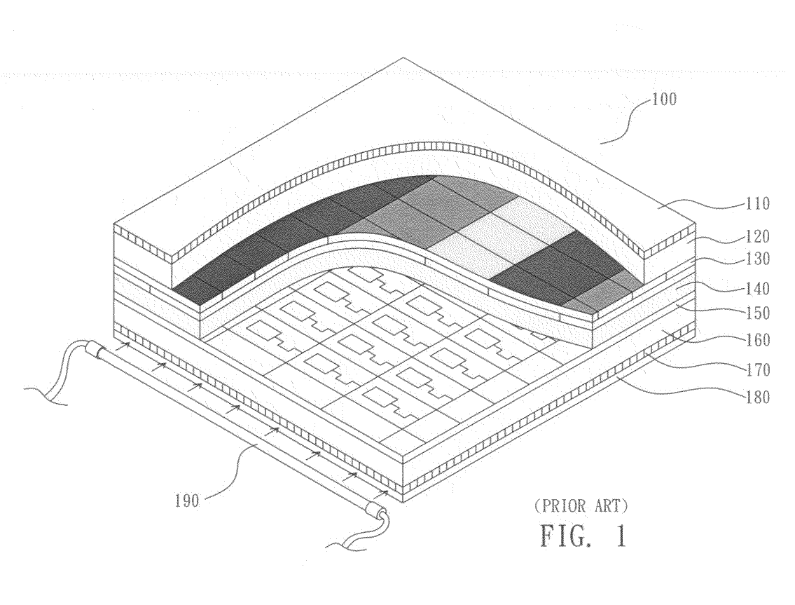

The upper polarizer 10, the upper glass substrate 20, the liquid crystal layer 30, the thin-film substrate 40, the lower glass substrate 50, the lower polarizer 60, and the backlight panel 70 function in the same manner as the like parts in the prior art design shown in FIG. 1. Because these parts are of the known art and not within the scope of the present invention, no further detailed description in this regard is necessary.

The LED backlight unit 80 is provided at one side of the backlight panel 70, and controllable to emit a first light source, a second light source and a third light source to the backlight panel 70. According to this embodiment, the LED backlight unit 80 is provided at the left side of the backlight panel 70, comprising a plurality of LEDs (light emitting diodes) 81. According to this embodiment, the LEDs 81 are arranged in a line. Further, the LEDs 81 are RGB tri-color LEDs. According to this embodiment, the first light source is red light, the second light source is green light, and the third light source is blue light.

The upper polarizer 10, upper glass substrate 20, liquid crystal layer 30, thin-film substrate 40, lower glass substrate 50, lower polarizer 60 and backlight panel 70 constitute a LCD panel 75 for displaying images. The LCD panel 75 can be a monochrome gray-tone LCD panel or color LCD panel. According to this embodiment, the LCD panel 75 is a monochrome gray-tone LCD panel for the advantage of low manufacturing cost.

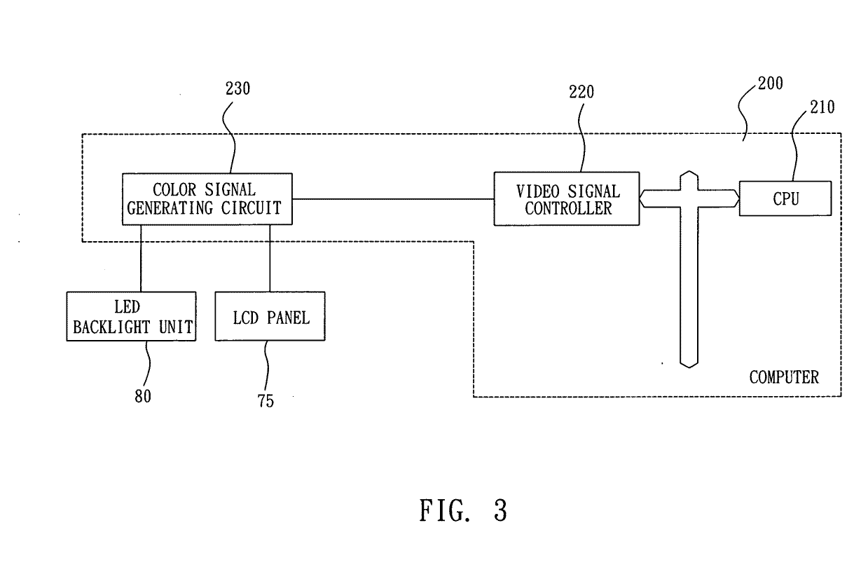

Referring to FIG. 3, display system of the present invention is connected to a computer 200 to receive image signal from the computer 200. The display system of the present invention can be connected to the computer 200 by a cable or wirelessly. The computer 200 comprises a CPU (central processing unit) 210, a video signal controller 220, and a color signal generating circuit 230.

The CPU 210 is the core of the computer 200, adapted to process data or execute other application programs. Because the CPU 210 is of the known technology, no further detailed description in this regard is necessary.

The video signal controller 220 is coupled to the CPU 210, and adapted to output a color video and to decompose the color video into an original digital video-R, an original digital video-G, and an original digital video-B.

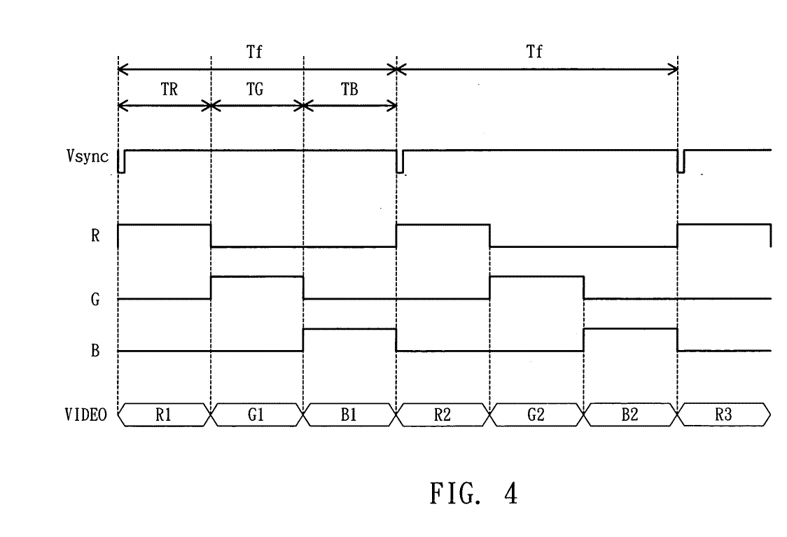

The color signal generating circuit 230 is coupled to the video signal controller 220 to receive the original digital video-R, the original digital video-G and the original digital video-B from the video signal controller 220, and to output a digital video-R, a digital video-G and a digital video-B to the LCD panel 75 and the LED backlight unit 80 for display subject to the time sequence shown in FIG. 4 in which Tf indicates the length of time of one picture frame; TR indicates length of time of one digital video-R; TG indicates length of time of one digital video-G; TB indicates length of time of one digital video-B. By means of TDM (Time Division Multiplexing), the color signal generating circuit 230 outputs R1, G1, B1, R2, G2, B2, R3, . . . video signals to the LCD panel 75 and the LED backlight unit 80.

During operation, the video signal controller 220 decomposes the original color image into an original digital video-R, an original digital video-G and an original digital video-B, so that the color signal generating circuit 230 outputs a first single-color video R1, a second single-color video G1 and a third single-color video B1 to the LCD panel 75 subject to the time sequence shown in FIG. 4. At this time, the LCD panel 75 uses the backlight source of the first light source, second light source and third light source to synthesize the first single-color video R1, the second single-color video G1 and the third single-color video B1 into a color image for display on the LCD panel 75. For example, the color signal generating circuit 230 can output in proper order a red color of first single-color video image R1, a green color of second single-color video G1 and a blue color of third single-color video B1 to the LCD panel 75. These three different colors are mixed, thereby synthesized into a color video image. Thus, the monochrome gray-tone LCD panel 75 can display the color image. Because the LEDs 81 are arranged in a line, it is necessary to output multiple rows of monochrome video data in proper order by means of time sharing for composing a whole red, green and blue video image.

Further, because the LED backlight unit 80 is comprised of RGB Tri-color LEDs 81, it simply requires a regular low voltage DC power source about 1.5˜5V. This feature simplifies the circuit layout and fabrication cost, avoiding the risk of a high voltage circuit.

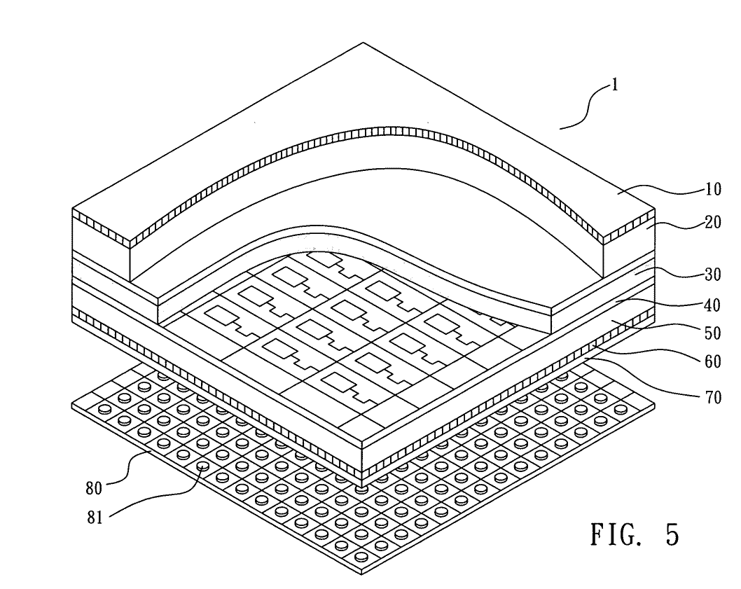

FIG. 5 illustrates an alternate form of the LED backlight unit 80. According to this embodiment, the LED backlight unit 80 is provided at the bottom side of the backlight panel 70. The LEDs 81 of the LED backlight unit 80 is arranged in an array for outputting the red color of first single-color video image, the green color of second single-color video and the blue color of third single-color video at a time.

The main feature of the present invention is the use of RGB Tri-color LEDs 81 to compose a backlight unit 80, which is used with any of a variety of LCD panels to form a display system.

### EXAMPLE I

The backlight set is assembled with the color LCD panel 100 shown in FIG. 1 to form a display system. The color LCD panel 100 comprises a color filter 130. Under the consideration of transmittancy (light energy utilization efficiency), the red, green, and blue transmissive wavelength is limited to a certain range, for example, 50 nm or more. However, the light emitted by each LED 81 is a single color of which the half-wave width is about 30 nm on blue color, or about 25 nm on red color. Therefore, it shows excellent effect on every color, and the single color light emitted by every LED 81 can go through the color filter completely. Therefore, the color LCD panel 100 needs light energy only about ⅓ or less when compared to the prior art design, saving much power consumption.

### EXAMPLE II

The backlight set is assembled with a regular color LCD panel similar to that shown in FIG. 1 with the exception that the aforesaid color filter 130 is eliminated and each pixel is divided into R, G. and B zones. Similar to the aforesaid first example, this second example saves much power consumption. Further, because this second example eliminates the color filter 130, the cost of the display system is greatly reduced (the cost of a color filter is about 26% in a 15″ color LCD panel).

### EXAMPLE III

The backlight set is assembled with a monochrome (black-and-white) gray-tone LCD panel to form a display system, reducing much the cost. Under a same size and same resolution, every single pixel in a monochrome gray-tone LCD panel 75 is one single zone not to be divided into RGB three zones. Therefore, the circuit layout is simplified, and the pixel aperture area is tripled or more when compared with a regular color LCD panel, i.e., the transmittancy is about triple or more of that of a regular color LCD panel. Therefore, a display system made according to this third example requires light energy about (⅓)×(⅓)= 1/9 or less when compared to an equivalent color LCD system, saving much power consumption. When displaying a color image through a conventional color LCD panel, the images of RGB three prime colors may be dislocated. In a monochrome gray-tome LCD panel, RGB three prime colors are from the same location. Therefore this third example avoids image dislocation, and the mixed color will be highly close to the original color. In general, this third example greatly reduces the cost, saves much power consumption, and provides an excellent image displaying effect. Further, when compared with a regular color LCD panel having the same aperture area, the resolution of the monochrome gray-tone LCD panel is about 3 times better.

When a four-color (RGB plus yellow) LED backlight set or more than four colors LED backlight set is used to substitute for the aforesaid RGB Tri-color LED backlight set, the displayed color image is composed of four or more than four colors, and the displayed color is more natural.

As stated above, the invention provides a display system with LED backlight means, which uses a LED backlight set and a monochrome gray-tone LCD panel to display images, saving much the manufacturing cost and power consumption, and eliminating the drawbacks of conventional LCD display systems.

Although particular embodiments of the invention haves been described in detail for purposes of illustration, various modifications and enhancements may be made without departing from the spirit and scope of the invention.

What is claimed is:

1. A display system comprising:
a backlight panel;
a LED backlight set adapted to emit a first light source, a second light source, and/or a third light source to said backlight panel;
a LCD panel disposed at a top side of said backlight panel; and
a video signal controller adapted to output a first monochrome video image, a second monochrome video image, and/or a third monochrome video image to said LCD panel for synthesizing into a color video image for display on said LCD panel.

2. The display system as claimed in claim 1, wherein said video signal controller is provided in a computer and coupled to a color signal generating circuit of said computer for producing said first monochrome video image, said second monochrome video image, and/or said third monochrome video image and a predetermined time sequence.

3. The display system as claimed in claim 1, wherein said LCD panel is comprised of an upper polarizer, an upper glass substrate, a liquid crystal layer, a thin-film substrate, a lower glass substrate, a lower polarizer, and a backlight panel.

4. The display system as claimed in claim 1, wherein said LED backlight set is disposed at one peripheral side of said backlight panel, comprising a plurality of light emitting diodes arranged in a line.

5. The display system as claimed in claim 4, wherein said light emitting diodes are RGB Tri-color light emitting diodes; said first light source, said second light source and said third light source are red, green and blue color light sources respectively.

6. The display system as claimed in claim 1, wherein said LED backlight set is disposed at a bottom side of said backlight panel, comprising a plurality of light emitting diodes arranged in an array.

7. The display system as claimed in claim 6, wherein said light emitting diodes are multi-color light emitting diodes; said first light source, said second light source and said third light source are red, green and blue color light sources respectively.

8. The display system as claimed in claim 1, wherein said LCD panel is a monochrome gray-tome LCD panel.

9. The display system as claimed in claim 1, wherein said LCD panel is a color LCD panel.
